(19) United States
(12) Patent Application Publication
(10) Pub. No.: US 2008/0073298 A1
(43) Pub. Date: Mar. 27, 2008

(54) Filter having opposing parallel planes of wedge wires

(75) Inventors: Kevin W. Smith, Houston, TX (US); Robert L. Sloan, Katy, TX (US); Harry D. Smith JR., Montgomery, TX (US)

Correspondence Address: William L. Krayer, 1771 Helen Drive, Pittsburgh, PA, 15216, US

(73) Assignee: Total Separation Solutions LLC

(21) Appl. No.: 11/906,463

(22) Filed: Oct. 2, 2007

Related U.S. Application Data
(63) Continuation-in-part of application No. 11/374,234, filed on Mar. 13, 2006.
(60) Provisional application No. 60/662,065, filed on Mar. 14, 2005.

(51) Int. Cl. B01D 39/00; B01D 43/00

(52) U.S. Cl. 210/806; 210/486; 210/808

(57) ABSTRACT

A screen for separating solids and liquids is formed from parallel strips of wedge wire or similar material into a two-sided enclosure having the flat bases of the wedge wires oriented to contact dirty liquid. Unfiltered liquid containing solids contacts the screen surface on both sides of the enclosure, forming a passage for filtrate. A wedge wire screen may be bent back on itself to form a C-shape or may be a closed curve, still exposing only the flat sides of the wedge wires to the dirty liquid, and collection filtrate within the enclosure so formed. Filter units may be placed in a housing adapted to accommodate two or more in a substantially concentric relationship.

### RELATED APPLICATION

This is a continuation-in-part of application Ser. No. 11/374,234 filed Mar. 13, 2006, which claims the full benefit of Provisional Application 60/662,065 filed Mar. 14, 2005.

### FIELD OF THE INVENTION

Substantially concentric convex and concave wedge wire filtering surfaces are formed into an enclosure that will fit into a housing. Filtrate from both filtering surfaces passes to a common space in both dead-end and cross-flow modes. High throughputs and separation efficiency are obtained.

### BACKGROUND OF THE INVENTION

Good screening and filter throughput is desirable for many high volume fluid handling operations, such as filtering and screening of well completion and workover fluids, but has been difficult to sustain in the varied and generally hostile conditions of many well drilling and producing operations. Backwashing is also sometimes inefficient because of the design of the solids separation device.

### SUMMARY OF THE INVENTION

We have developed a new design for a filter or screen which overcomes to a large degree the difficulties recited in the background of the invention; namely the invention provides a sustainable throughput for large volumes of fluid, and the ability efficiently to backwash. The invention provides that two wedge-wire screens are formed into elongated substantially concentric or parallel shapes so that the flat sides of the wedge wires acting on the liquid to be filtered will form a common space for the filtrate.

### BRIEF DESCRIPTION OF THE DRAWINGS

FIG. 1 illustrates a prior art technique for manufacturing a cylindrical wedge wire screen.

FIG. 2 is a simplified section of a cylindrical two-section concentric screen of the invention.

FIG. 3 is a perspective of a construction similar to that of FIG. 2.

FIG. 4 is an “exploded” view of the screen device, including the end units.

FIG. 5 is an overhead view of the top plate of the reservoir which facilitates collection of the filtered fluid.

FIG. 6 shows a C-shape screen in the configuration of a candle filter.

FIG. 7a is a simplified sectional view of two oppositely oriented C-shaped filters, the C-shape being somewhat “squashed.”

FIG. 7b shows two oppositely facing wedge wire screens attached to each other to form a portion of a variation of our invention. FIG. 7c illustrates a further variation wherein a fabric may be used as an outer filtration surface.

FIG. 8 is a view of a double filter having a closed oval shape.

FIG. 9 illustrates the operation of a filter similar to FIG. 7a or 8.

FIG. 10 is a detailed, somewhat idealized view of the operation of our filters.

FIG. 11 is an overhead or sectional view of a filter of our invention made from a single sheet of wedge wire.

### DETAILED DESCRIPTION OF THE INVENTION

The invention is illustrated in terms of a wedge wire screen, but the C-shape enclosure to be described below is applicable to other types of screens and to filters, as will be explained.

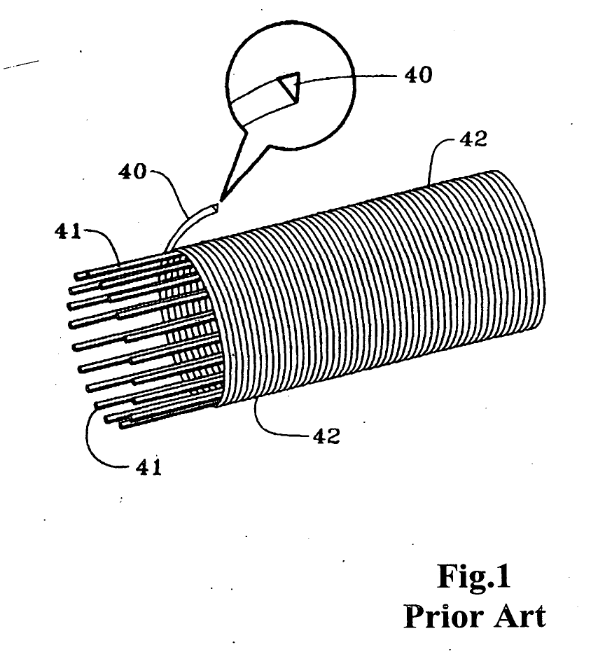

FIG. 1 is a detail of the construction of a wedge wire screen useful in the invention, which can be placed in various positions. As is known in the art, a screen can be made by winding a wedge wire 40, an extruded, triangular section wire, around a cage of parallel ribs 41, fixing them to form a space or slot 42 of a desired opening dimension between them, usually by welding. The ribs may lie on the outside of the unit instead of the inside as shown, and may be welded to either a flat side of wedge wire 40 or to an edge as shown. We may use the ribs in any of these variations, but generally, since we believe it is desirable to use the flat sides of the wedge wires for the retentate side of the filter surface, we prefer that the ribs be welded or otherwise fixed to the longitudinal edges of the wedge wires. They need not be helically wound as shown in FIG. 1, but can be made in flat sheets, of predetermined segments of wedge wires. It is not essential that the wedge wires used in our invention have a delta-shaped profile. We include in the term “wedge wire” wires or extrusions (metal or plastic) having a trapezoid profile; see, for example, the shapes illustrated in U.S. Pat. No. 5,476,588. We may refer to the flat side of the wedge wire which contacts the dirty fluid or retentate as the “base” of the wedge wire; in the case of a trapezoid form, the base is the widest side of the polygon—the sides next to the base, in profile, must be at acute angles from the base. Bases of the wedge wires form the outer, or retentate, sides of the filter.

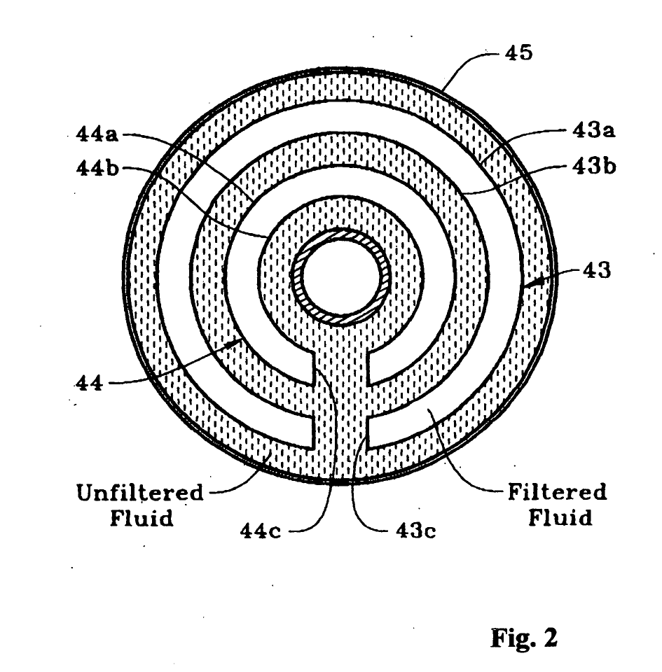

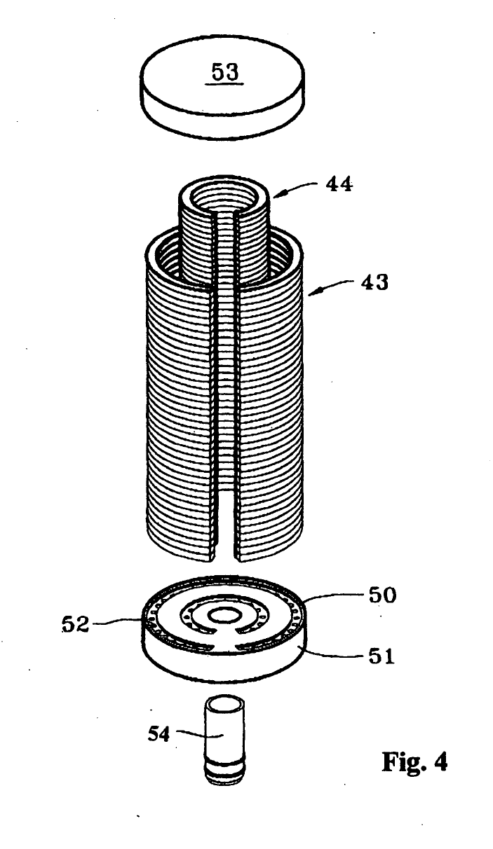

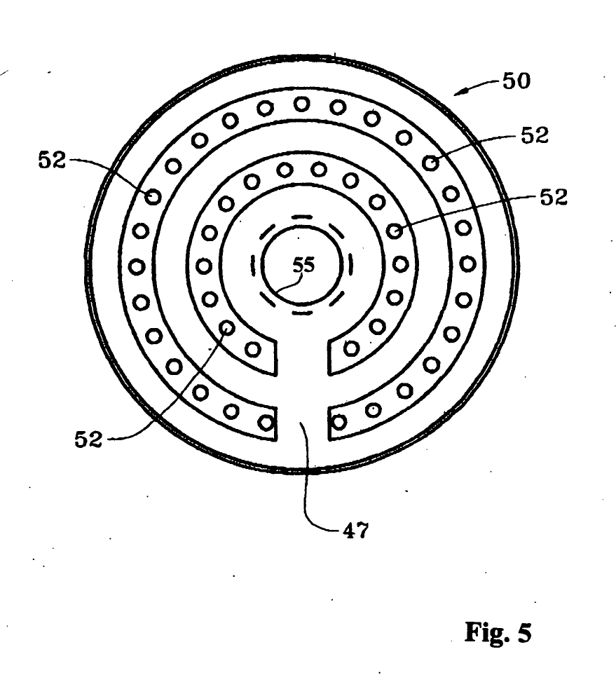

FIG. 2 is a simplified sectional view of the construction of a substantially cylindrical filter or wedge wire screen of my invention. Here, there are two C-shaped screen units 43 and 44 set substantially concentrically in a cylindrical housing 45. Each screen unit 43 and 44 has a convex face 43a and 44a, and a concave face 43b and 44b, both of which are to be contacted by unfiltered fluid, represented here by the shaded areas. Each screen unit 43 and 44 also has end caps 43c and 44c, which may be impervious—that is, it need not be of wedge wire or other screen material. Together with the concave and convex faces, and, together with the fact that I seal the C-shaped units at the top and bottom, the end caps form an enclosure. Unfiltered fluid enters the cylindrical housing 45 through inlets not shown (from anywhere through the housing 45, or its top, provided it passes into a portion of the shaded area labeled “unfiltered fluid) and passes through the separator media (such as wedge wire screens) of both the convex and concave sides of the screen units, leaving solids of the undesired size behind. Filtered or screened fluid within the screen units may then be removed through outlets 52 as illustrated in FIGS. 4 and 5. It should be noted that both the convex faces 43a and 44a, and the concave faces 43b and 44b of the screen units are constructed so that, if they are made of wedge wire, the flat side of the wedge wire contacts the unfiltered fluid. One of the features of wedge wire screens is that a solid particle is not likely to become lodged in a slot 42 because the anterior of the slot is divergent, i.e. the slot is between two triangular shapes opening to the interior of the filter surface. Thus the construction of the concave faces 43b and 44b is opposite the convex orientation shown in FIG. 1, the wedge wire being laid on the inside of ribs 41 rather than the outside; nevertheless, the unfiltered fluid contacts only flat surfaces defining the slots 42 (FIG. 1). A generally C-shaped face 43a or 43b can be made by making a longitudinal cut in the wedge wire screen of FIG. 1. A concave filter or screen surface may be made by bending a cylindrical surface such as that made in FIG. 1 so that the flat surfaces face inwardly. Of course, “sheets” of wedge wire screen can be made by welding or otherwise fixing precut lengths of wedge wire to parallel ribs on a plane or flat surface and then bending them to the desired form.

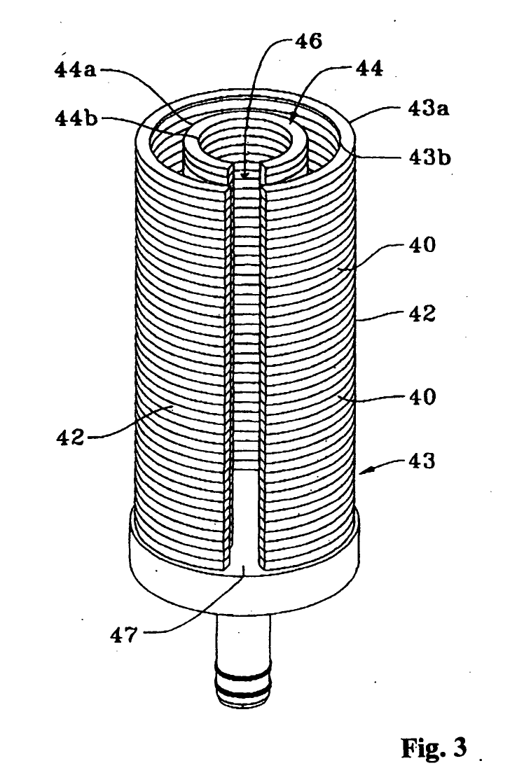

As indicated above, such flat sheets may be made by welding or otherwise securing either a longitudinal edge or a flat side of the wedge wire to the ribs. It may be observed that if a sheet of wedge wires is bent over an axis perpendicular to the wedge wires, the spacing between them is unaffected, but if the axis around which the sheet is bent is parallel to the bending, the spaces will either enlarge or contract depending on the direction of the bend. See FIG. 2 of Nagaoka U.S. Pat. No. 5,858,235 for an example of a cylindrical shape with the wedge wires running parallel to the axis; also FIG. 3 or 4 of Norell et al U.S. Pat. No. 6,698,595. The wedge wires in these depictions are of precut lengths rather than a long helical strand in the present FIG. 1. We may use any such construction.

FIG. 3 is a perspective of the two-enclosure, substantially concentric, configuration, without the housing 45. Wedge wires form the entire convex (43a and 44a) and concave (43b and 44b) faces of the C-shaped screen units. Slots 42 of the desired dimension are established between wedge wires 40. In the configuration of FIG. 3, C-shaped screen unit 43 is shown with its elongated opening 47 aligned with elongated opening 46 of C-shaped screen unit 44, but this is not essential—that is, screen unit 44 could be turned, for example, 180 degrees so that opening 46 is oriented away from opening 47 of screen unit 43.

Referring now to FIGS. 4 and 5, the top plate 50 of reservoir 51 is seen to have outlets 52 for filtered fluid having passed through the wedge wire screens of screen units 43 and 44. When assembled, housing 45 and the two screen units 43 and 44 are sealed to top plate 50. Filtered fluid collects in reservoir 51 and is removed through pipe 54. A cylindrical screen 55 constructed as in FIG. 1 may reside in the center of inner enclosure 44, providing additional volume for the collection of filtered fluid. FIG. 4 is an exploded view of the top seal 53, screen units 43 and 44, reservoir 51 with its top plate 50, and pipe 54. Housing 45 and the inlet for the dirty fluid are not shown in this view. FIG. 5 is an overhead view of top plate 50, showing the deployment of outlets 52 for screen units 43 and 44.

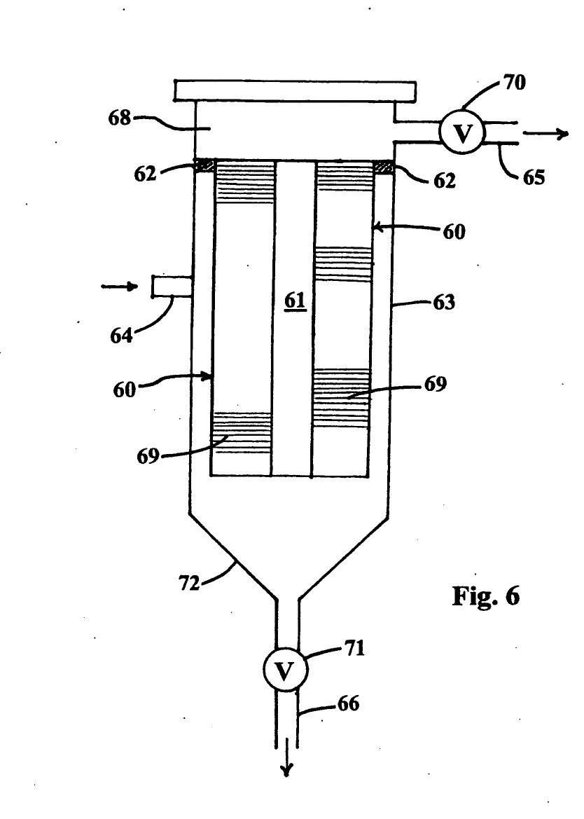

FIG. 6 shows the use of my C-shaped wedge wire screen in a candle filter construction, in a more or less diagrammatic fashion. The C-shaped wedge wire screen 60 is viewed from its opening 61. The screen 60, made of wedge wires 69 in a manner similar to that of FIG. 1, is located and fixed next to a ledge 62 near the top of vessel 63. C-shaped wedge wire screen 60 is essentially the same shape and structure as screen unit 43 or 44 in FIG. 2 (having spaces not shown, similar to slots 42 in FIGS. 2 and 3), but here we are looking directly at the opening 61 (equivalent to openings 46 and 47 in FIG. 3), although the screen 60 is entirely enclosed in vessel 63. Vessel 63 has an entrance 64 (which may preferably be oriented toward opening 61) for dirty fluid, an exit 65 for clean fluid, and a drain 66 for solids and concentrated dirty fluid. The lower end 72 of the vessel 63 has a shape similar to a funnel so that solids may collect and drop by gravity to drain 66. The wedge wire screen 60 is constructed in a sense opposite to that of FIG. 4 in that the clear filtered fluid is taken off the top and sent through exit 65 instead of through the bottom; solids and dirty fluid exit in the bottom. For these purposes, it should be noted that the top of wedge wire screen 60 may be completely open to the clean fluid collection chamber 68; on the other hand, the bottom of the wedge wire screen 60 should either be sealed or closed off with a screen material, so that solids and dirty water will not enter the wedge wire screen 60 from the bottom. Valves 70 and 71 may be used to control the flow out of the vessel 63.

A screen such as depicted in FIGS. 1-6, or any other effective screen, may advantageously be placed immediately upstream of a viscometer to protect the viscometer from solids, or just ahead of a filter, to remove solids larger than the filter is designed for. In addition to removing potentially damaging solids, the wedge wire screen can perform the function of breaking up “fish-eyes” or other localized gel blobs, as well as shearing a viscous fluid, sometimes delaying the point at which the fluid is diverted or at which the pump is shut down.

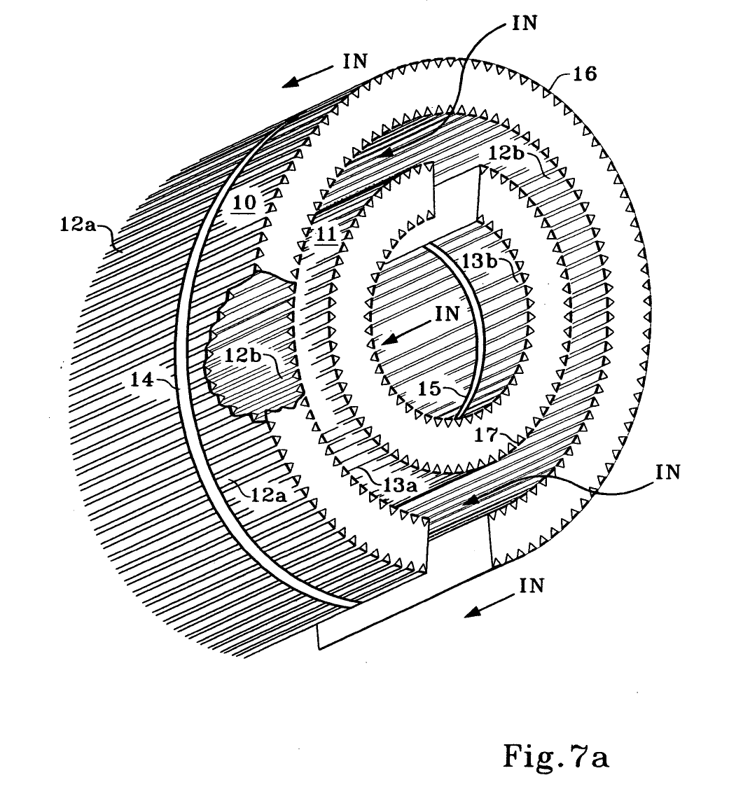

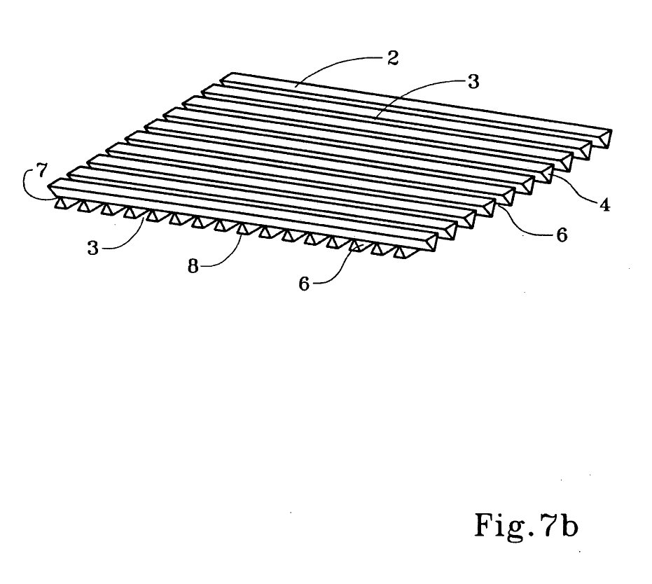

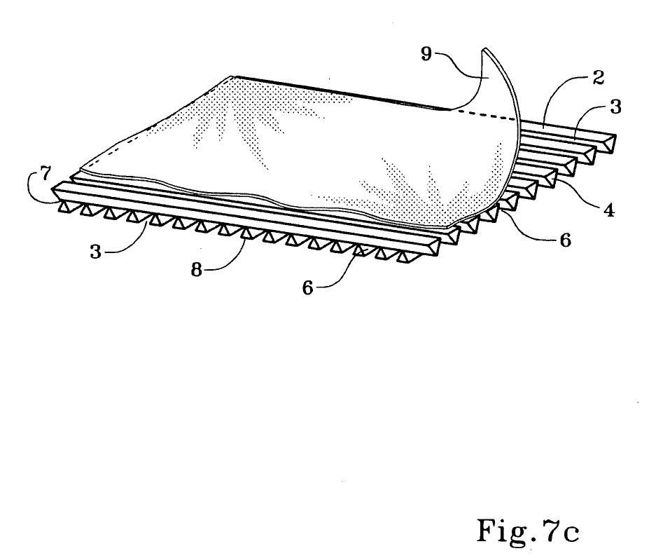

Referring now to FIG. 7a, a section of a double C-shaped filter is shown ready for placement in a housing (not shown) of suitable shape. Here, both the larger filter 10 and the smaller filter 11 utilize wedge wires running lengthwise on the filter surface, covering the entire longitudinal surfaces of each of the filters. The wedge wires on both filters 10 and 11 run parallel to the axis of the “squashed” C-shaped unit. Wedge wires 12a and 12b of filter 10, and 13a and 13b of filter 11, are welded or otherwise secured to generally orthoganally placed ribs 14 and 15. Ribs 14 and 15 can be on either the convex or concave sides of the filter face and either the retentate or filtrate side. Similar to the constructions of FIGS. 2, 3, and 4, the filter units are closed beyond ends 16 and 17, but need not be if a cap for the housing is to be used which will seal off the tops of the filter units. Wedge wires 12a, the outer wedge wires, and 12b, the inner wedge wires, are on opposite sides of filter 10, and wedge wires 13a, the outer wedge wires, and 13b, the inner wedge wires, on opposite sides of filter 11, are oriented with their flat sides facing the liquid to be filtered—the spaces labeled “IN.” The flat sides of the wedge wires thus form the “outer” or “retentate” sides of the filter as those terms are used herein. On the convex surfaces of each filter, the spaces between the wedge wires will be widened as the curvature of the surface increases, and on the concave surfaces the spaces between wedge wires will be narrowed. If it is desired to have the spaces on both the concave and convex sides of the filters of equal width, this can be accommodated by appropriately altering the spacings between the flats of the wedge wires before the wedge wires are shaped into the desired configuration. Filtrate passes to the spaces within the C-shaped filters 10 and 11 This double C-shaped filter can be utilized in either the dead-end or cross-flow mode. In either mode, incoming fluid can flow freely into all the spaces labeled “IN,” from any other space labeled “IN,” subject to the connections, pressure differences, and resulting planned flow patterns within a particular housing.

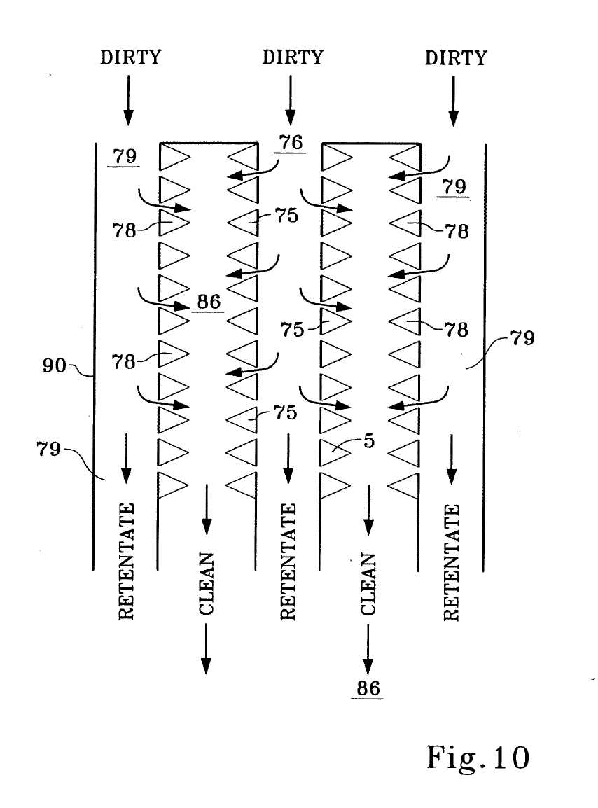

In the configuration where the convex and concave wedge wires are perpendicular to each other (i.e. if one is horizontal and the other is longitudinal), then the ribs can be eliminated in some instances by fixing points where the apexes of the opposing wedge wires come into contact. This is illustrated in FIG. 7b, where a portion of a filter of our invention is shown. FIG. 7b shows a filter surface made of the flat sides of parallel wedge wires 2 aligned to form slits 3, with their triangular or delta profiles 4 forming immediately diverging channels 6 between the wedge wires. Parallel wedge wires 2 are fastened, such as by welding or sintering, at the intersections 7 to a similar plurality of parallel wedge wires 8, also having slits 3 between them of a dimension capable of retaining solids of the desired size, and also forming diverging channels 6 between them. The two substantially parallel planes of wedge wires comprise a filter of our invention, able to receive dirty fluid and act as retentate surfaces on both outer surfaces—that is, both surfaces made up of the flat sides of the wedge wires. Filtrate passing through slits 3 will be able to flow in any direction (whatever the pressure differences and flow patterns of the filter dictate) through the diverging channels 6 and otherwise between the two joined, perpendicularly oriented, sheets of wedge wires. Slits 3 are not illustrated in the other figures herein except FIG. 10 which illustrates the flow of filtrate through them, but are always present, in varying widths, between the wedge wires in our invention. It is not essential that the opposing, contacting, wedge wires be perpendicular to each other. Angles other than ninety degrees are possible and useful, so long as the opposing, and contacting, faces are not parallel. That is, the angle should be sufficiently greater than 0° so that the narrower portions of the wedge wires on the two sets will contact each other and can be secured in place.

In FIG. 7c, a nonwoven fabric 9 may be seen covering the retentate surface of the parallel wedge wires configured as in FIG. 7b. Our invention contemplates the use of a woven or nonwoven fabric as an outer filtration surface; that is, a filter medium for contacting the dirty fluid before it contacts the wedge wire retentate surface in any of the configurations shown or contemplated herein. The fabric may completely enclose the wedge wire units. For example, a fabric cover may completely enclose C-shaped filters 10 and 11 in FIG. 7a. The wedge wire retentate surface thus not only serves as a filtering medium but as support for the fabric. Backwashing of such a fabric-covered filter will in some instances be more readily accomplished because the fabric will tend to flex away from the support, causing the filter cake to disperse. The fabric may be woven or nonwoven, synthetic or not, mono or multifilament, and of various permeability ratings. We intend for the term “fabric” to include all such possibilities.

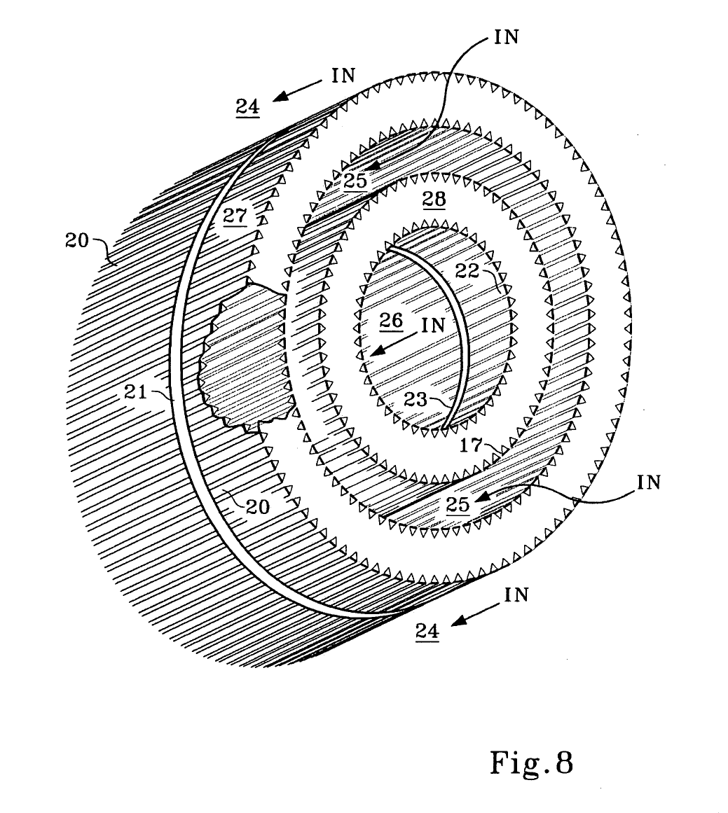

FIG. 8 demonstrates that our filter form can be a closed curve. As with the other variations of our invention, the flat faces of the wedge wires are oriented toward the liquid to be filtered on both sides of the space or enclosure formed to collect the filtrate. Here, longitudinal wedge wires 20 forming the outer shell or retentate surface are placed completely around the “squashed” tubular or oval shape of outer two-faced filter 27, and are secured by annular ribs 21. Wedge wires 22 on the concave side of two-faced squashed cylinder inner filter 28 also are shown running longitudinally and are secured to annular ribs 23. Ribs 21 and 23 may be placed on the sides of the wedge wires opposite to those shown. The inner and outer squashed cylinder filters 27 and 28 can, but need not be, completely independent parts prior to placement in the housing, as the housing can hold them in a substantially concentric relationship or otherwise if desired. If it is desired to fix them in position with respect to each other prior to placement in the housing, this can be easily done with struts or other framework not shown. It should be observed that, because the oval forms of the squashed cylinders are closed—that is, they do not have a longitudinal opening as the C-shaped filter of FIGS. 3 and 7—liquid not yet filtered cannot move freely between or among retentate passages 24, 25 and 26 unless the cap and/or base of the housing (not shown) permits such flow or other connections are made to permit it.

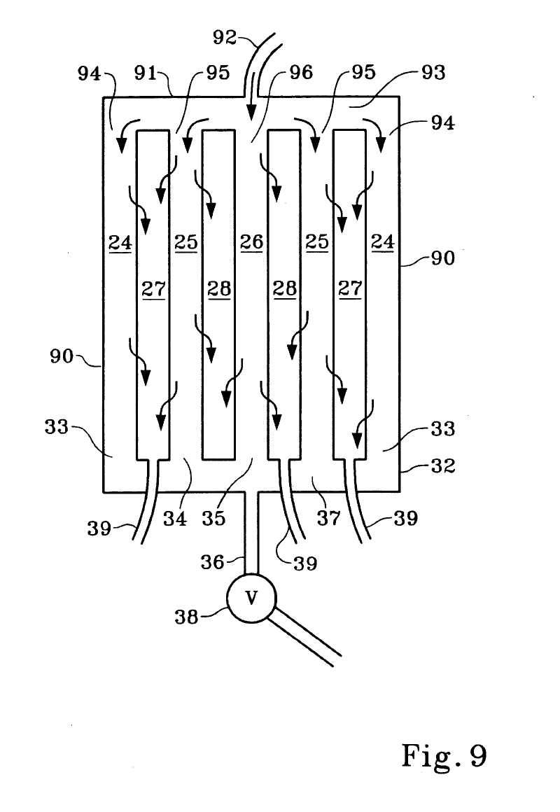

FIG. 9 is a simplified diagrammatic vertical section of a filter form similar to FIG. 7a or 8 operating in a housing. Housing 90 surrounds the filter form. Cap 91 has an inlet 92 for the liquid to be filtered. Inlet 92 leads to manifold 93 which has openings 94 for exterior passage 24, and 95 and 96 for interior passages 25 and 26. Cap 91 otherwise seals off the top of the oval-shaped filter unit. At the lower end, as depicted, of housing 90 is base 32, having openings 33 for retentate from exterior passage 24, 34 for interior passage 25, and 35 for interior passage 26. In the cross-flow mode, retentate will flow from passages 24, 25, and 26 into manifold 37 and continue into conduit 36 for transport to another filter, to a disposal site, to be recycled, or to a system for recovering valuable components from the retentate. For these purposes, valve 38 will be open, but it may be closed, which will convert the operation of the filter into the dead end mode. In the dead end mode, solids may accumulate in manifold 37 and possibly in passages 24, 25, and 26. In either the dead end or cross flow mode, clean fluid or other filtrate will flow from passages 24, 25, and 26 transversely into filters 27 and 28 and then to conduits 39 for collection or utilization as desired. As indicted elsewhere herein, the wedge wires (not shown in detail) forming filters 27 and 28 may run horizontally or vertically, in the same direction on all filter faces or not.

FIG. 10 is an exemplary vertical sectional detail of portions of passages such as passages between wedge wires 13a and 13b in FIG. 7a, although here there is only one filter unit, and here horizontal wedge wires rather than vertical wedge wires are shown. Horizontal wedge wires may be either precut for the circumferential dimension or may be helically wound. Wedge wires 75 (corresponding to wedge wires 13b in FIG. 7a, in that they form an interior retentate surface) line the central passage 76, generally similar to the central passage interior to filter 11 in FIG. 7a, as only one C-shaped filter is shown in FIG. 10. Wedge wires 78, (corresponding to wedge wires 13a in FIG. 7a), together with housing 90, form exterior passage 79, shown on both sides of the figure. Dirty fluid contacts only the flat sides of wedge wires 75 and 78. The wedge wires are held in place by ribs not shown.

A known virtue of a wedge wire screen is that the narrow entrances of the slots between the wedge wires are virtually two-dimensional—that is, the immediate divergence of the space between wedge wires encourages the flow of the filtrate. Dirty fluid entering the top, as depicted, of passages 76 and 79 is subjected to excess pressure relative to the pressure in the permeate passage 86, which causes clean filtrate to pass through slots between wedge wires 75 and 78, and flow as shown by the arrows, separated from the retentate. In the cross flow mode, the retentate continues through the passages 76 and 79, while in the dead end mode, the only fluid exit is the permeate passage 86 formed by the substantially parallel or concentric wedge wires 75 and 78, permeate passage 86 being accessible only by permeate passing between the wedge wires. Solids and other retentate material are thus accumulated in passages 76 and 79 or further downstream as in manifold 37 of FIG. 9. A few of the wedge wires 5 have been depicted optionally as having a trapezoidal profile. As the wedge wires are normally extruded in manufacture, this profile is not difficult to make using the appropriate die, and as indicated above the trapezoidal profile is included in the term wedge wire as used herein along with the more common deltoid form.

As FIG. 10 is a micro and idealized view of the operation of our invention, the wedge wire screens are shown in substantially parallel planes. We intend to include within the phrase “substantially parallel planes” both flat planes and curved planes, as can be seen from the figures herein—in particular, we consider substantially concentric planes, and the various “squashed” and bent forms of FIGS. 7, 8, and 11, and other shapes which may not maintain constant dimensions between them, to be within the term “substantially parallel planes.” Generally, two opposing sheets of wedge wires, or opposing portions of the same sheet of wedge wires, are deployed to form an enclosure or passage for filtrate passing into it from both sides after the dirty fluid has contacted the bases of the wedge wires under pressure on both sides of the enclosure. Persons skilled in the art will recognize that the pressures on both sides (on the retentate sides) will normally be substantially equal, and the pressure within the enclosure will normally be lower than that on the retentate sides. The pressure differential between the retentate and permeate sides of these filters can also be achieved by pulling a vacuum on the permeate side of the filter as opposed to exerting excess pressure on the retentate side. Further, we do not intend for the invention always to be used by flowing the retentate and the filtrate in the same direction. Countercurrent flow is also contemplated within our invention.

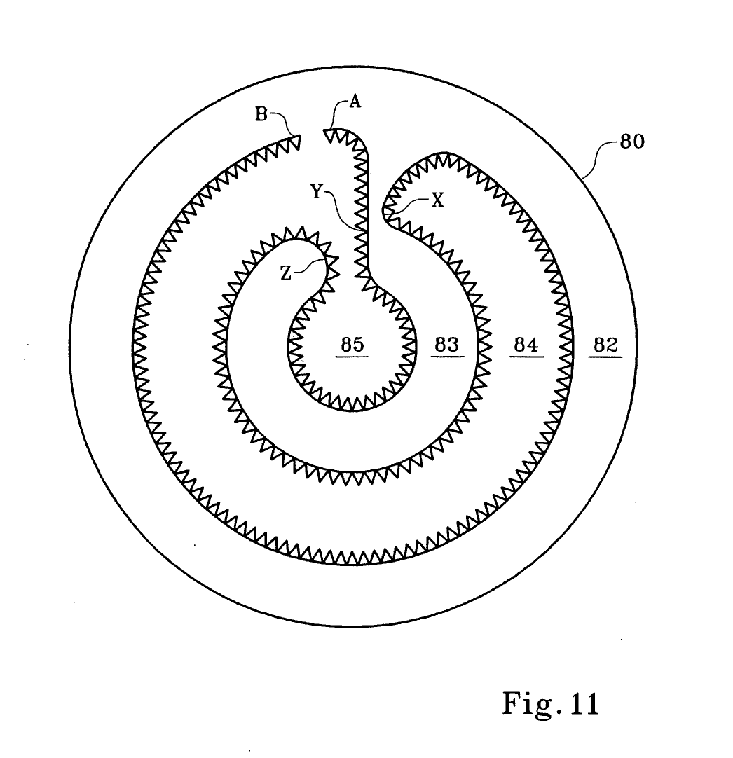

FIG. 11 shows how one configuration of a filter of our invention can be made from a single sheet of wedge wire for insertion in a housing 80. As indicated above, the wedge wire screen may be made of plastic, such as polypropylene or any other conveniently extruded synthetic polymer; ribs may be plastic or metal. From this overhead or sectional view of the longitudinally oriented wedge wires, it can be seen that a single sheet beginning at end A can be bent as shown and then connected to a single point (the full length of the wedge wire screen) at X, Y, and Z so that the flat sides of the wedge wires are oriented as shown. The two ends A and B are also connected. The shape thus formed defines an external passage 82 and an internal passage 83, each for incoming dirty fluid under pressure. In this particular configuration, filtrate passage 84 is fed from both passages 82 and 83 according to the precepts of our invention (the dirty fluid encountering the flat sides of the wedge wires on the filtering, retentate surfaces), while central filtrate passage 85 receives filtrate from only one transverse direction—that is, from internal passage 83. Continued, additional, “wrap-arounds” using longer sheets can be employed to construct filters with additional filtrate passages fed from both sides as contemplated in our invention. If the central passage 85 is constructed with the flat sides of the wedge wires facing inwardly, and the rest of the wrap-arounds follow a pattern as shown, dirty fluid can be fed to the central passage and a further outer passage. Filters 10 and 11 in FIG. 7a can be constructed from single sheets, as can filters 43 and 44 of FIG. 4, for example.

Thus, our invention includes a filter having two retentate surfaces in substantially parallel planes, the retentate surfaces comprising the flat bases of a plurality of wedge wires. We mean by “retentate surface” the surface which will contact the dirty fluid to be filtered, sometimes herein called the outer surface. When in an appropriate housing, the two parallel planes will help to define an interior path for filtrate. Our invention also includes a filter comprising two sets of parallel wedge wires, the wedge wires having a substantially triangular, trapezoidal or deltoid profile including a substantially flat base and an apex or side narrower than the base opposite the base, each set of parallel wedge wires forming a filter surface (a retentate surface) comprising the substantially flat sides of the wedge wires, the two sets of parallel wedge wires being oriented and in contact with each other at an angle not parallel with each other, forming intersections with each other, and secured to each other at the intersections.

1. A device for separating solids from liquids comprising a generally cylindrical enclosure, the generally cylindrical enclosure having an axis, and a first substantially cylindrical screen member within said generally cylindrical enclosure, said substantially cylindrical screen member also having an axis, said axis being coexistent or substantially parallel to the axis of said cylindrical enclosure, said substantially cylindrical screen member comprising a convex screen and a concave screen, said convex screen and said concave screen being connected in sealed relationship and defining a space between them whereby, when said substantially cylindrical screen member is contacted with liquid containing solids, at least some solids will be retained on said screen member and said liquid will pass through said convex and concave screens to said space.

2. The device of claim 1 wherein said substantially cylindrical screen member has a substantially linear opening, said substantially linear opening being substantially parallel to its axis, whereby said substantially linear opening facilitates contact of said liquid containing solids with said convex screen.

3. The device of claim 1 wherein said cylindrical enclosure has at least one inlet for contacting said liquid containing solids with said concave screen and said convex screen of said substantially cylindrical screen.

4. The device of claim 1 wherein said concave and said convex screens are wedge wire screens.

5. The device of claim 3 wherein said screen member has an outlet for liquid.

6. The device of claim 1 including a central, substantially cylindrical, screen.

7. The device of claim 1 including a second substantially cylindrical screen member comprising convex and concave screens, said second screen member being situated within said substantially cylindrical enclosure.

8. The device of claim 7 wherein said second substantially cylindrical screen member is substantially concentrically within said first substantially cylindrical screen member.

9. A solids/liquid separator comprising a first generally cylindrical screen having a screen surface facing outwardly, a second generally cylindrical screen of a diameter smaller than that of said first screen and having a screen surface facing inwardly, said second screen being situated substantially concentrically within said first screen, said first and second screens being connected in sealed relation to form a generally C-shaped profile and a space between said first and said second screens for collecting liquid filtrate.

10. A separator of claim 9 wherein said first and second screens are wedge wire screens.

11. A separator of claim 9 including a second separator of claim 9 within the C-shaped profile of said separator of claim 9.

12. A separator of claim 11 wherein said first and second separators comprise wedge wire screens.

13. A high volume separator comprising a plurality of devices of claim 1.

14. A high volume separator comprising a plurality of separators of claim 9.

15. The separator of claim 9 including a substantially cylindrical wedge wire screen within and substantially concentric to said generally C-shaped profile.

16. A substantially cylindrical device for separating solids and liquids comprising (a) a substantially cylindrical convex wedge wire screen and (b) a substantially cylindrical concave wedge wire screen, said substantially cylindrical concave wedge wire screen being fixed and sealed substantially concentrically within and apart from said substantially cylindrical convex wedge wire screen, whereby said convex and concave screens form an interior space.

17. The substantially cylindrical device of claim 16 having a C-shaped cross section.

18. A device for screening solids from liquids comprising at least one device of claim 16 enclosed and sealed within an enclosure having an inlet for liquid containing solids, said inlet providing access for said liquid to the convex surface of said convex wedge wire screen and also the to concave surface of said concave wedge wire screen.

19. The device of claim 18 in the form of a candle filter.

20. The device of claim 1 oriented in the form of a candle filter, having an opening at the top of said defined space, said device being substantially enclosed within a vessel having means for collecting and draining solids at the bottom thereof.

21. A filter medium having two retentate surfaces in substantially parallel planes, said retentate surfaces comprising the flat bases of a plurality of wedge wires.

22. The filter medium of claim 21 in a housing, said housing and said filter medium defining (a) flow paths for dirty liquid to contact both of said retentate surfaces of said filter medium and (b) an interior path for filtrate passing between said wedge wires on both of said retentate surfaces.

23. The filter medium of claim 21 having a substantially oval shaped cross section.

24. The filter medium of claim 21 having a substantially C-shaped profile.

25. The filter medium of claim 22 having a substantially C-shaped profile.

26. The filter medium of claim 21 substantially surrounded by a second filter medium of claim 21.

27. The filter medium of claim 21 made from a single sheet of wedge wire.

28. The filter medium of claim 21 enclosed by a fabric.

29. Method of filtering a liquid comprising contacting said liquid under pressure with both outer surfaces of a filter medium of claim 21 and collecting filtrate passing through both of said retentate surfaces of said filter medium.

30. Method of claim 29 wherein said filtrate passing through both of said retentate surfaces is collected in a common space between said retentate surfaces.

31. Method of claim 28 including passing said liquid through a fabric prior to passing it through said outer surfaces of said filter medium of claim 21.

32. A filter comprising two sets of parallel wedge wires, said wedge wires having a deltoid profile including a substantially flat base and a portion narrower than said base opposite said base, each set of parallel wedge wires forming a filter surface comprising said substantially flat bases of said wedge wires, said two sets of parallel wedge wires being oriented and in contact with each other on said narrower portions of said wedge wires so that said two sets of wedge wires form intersections with each other on said narrower portions, and secured to each other at said intersections.

33. The filter of claim 32 wherein said two sets of parallel wedge wires are oriented substantially perpendicularly to each other.
